(19) United States
(12) Patent Application Publication
(10) Pub. No.: US 2016/0132754 A1
(43) Pub. Date: May 12, 2016

(54) INTEGRATED REAL-TIME TRACKING SYSTEM FOR NORMAL AND ANOMALY TRACKING AND THE METHODS THEREFOR

(71) Applicant: THE JOHNS HOPKINS UNIVERSITY, Baltimore, MD (US)

(72) Inventors: Alireza Akhbardeh, Baltimore, MD (US); Michael A. Jacobs, Sparks, MD (US)

(21) Appl. No.: 14/403,663

(22) PCT Filed: May 25, 2013
(86) PCT No.: PCT/US2013/042869

§ 371 Date: Nov. 25, 2014

Related U.S. Application Data
(60) Provisional application No. 61/651,748, filed on May 25, 2012.

(51) Int. Cl. G06K 9/66; G06K 9/00; G06K 9/62; G06T 7/20; G06T 1/00

(52) U.S. Cl. CPC G06K 9/66; G06T 7/2006; G06T 1/00; G06K 9/6267; G06K 9/00771

(57) ABSTRACT

The ability to identify anomalous behavior in video recordings is important for security and public safety. Current identification techniques, however, suffer from a number of limitations. The present invention describes a novel identification technique that permits unsupervised, automatic identification of moving objects and anomaly detection in real-time recordings (MovA). The present invention specifically utilizes a novel real-time manifold learning system (RML), which generates a semantic crowd behavior descriptor that the inventors call a Trackogram. The Trackogram can be used to identify anomalous crowd behavior collected from video recordings in a real-time manner. MovA can be used to detect anomaly in standard video datasets. Importantly, MovA is also able to identify anomalies in night-vision stereo sequences. Ultimately, MovA could be incorporated into a number of existing products, including video monitoring cameras or night-vision goggles.

### CROSS REFERENCE TO RELATED APPLICATIONS

This application claims the benefit of U.S. Provisional Patent Application No. 61/651,748 flied on May 25, 2012, which is incorporated by reference, herein, in its entirety.

### FIELD OF THE INVENTION

The present invention relates generally to tracking systems. More particularly, the present invention relates to a system and method for providing real-time tracking.

### BACKGROUND OF THE INVENTION

The current systems and methods used for tracking can be classified into two categories: 1) Intra-Frame Processing (IntaF) to track individual crowd motions and behaviors within a sensor frame; 2) Inter-Frame Processing (InteF) for anomaly tracking to understand crowd behaviors and individuals motion patterns frame to frame and analyze trajectories to model normal and abnormal crowd behaviors. To perform these two aims, several methods such as optical flow, social force model, particle advection, hidden markov models, artificial neural networks and support vector machine have been developed to establish frame trajectories and a. crowd motion model to distinguish between normal and abnormal crowd behaviors.

Some of challenges and drawbacks found in these current methods and systems include: a) defining boundaries between normal and anomalous patterns and behavior is challenging and a learning process is needed to separate them; b) anomaly type is different for different applications; c) difficulties and availability of labeled data for training and validation; d) false positives in anomaly detection dramatically increase when data might contain noise; e) normal pattern and behavior could change over time; f) if the camera capturing video is not stationary most of above methods cannot model crow behavior; g) most of the current methods are designed for day usage and don't work at night; h) most of the existing methods are computationally expensive and need prior training and are not designed for real-time applications and embedding in an integrated system for carry-on-uses.

Accordingly, there is a need in the art for a method that allows for detecting in real time unsupervised and automatic moving objects and anomalies from stationary and non-stationary sensors.

### SUMMARY OF THE INVENTION

The foregoing needs are met, to a great extent by a system for detection of an object including a source of image data, wherein said image data comprises a frame. The system also includes a real-time learning manifold system (RML) disposed on a fixed computer readable medium. The RML includes a first subsystem configured to provide prediction of motion pattern intra-frame, such that the object is detected moving within the frame. Additionally, the RML includes a second subsystem configured to provide prediction of motion pattern inter-frame, such that changes over time in a scene contained in the image data are predicted.

In accordance with an aspect of the present invention, a method for real-time tracking includes obtaining K sample frames and collecting a current frame (F(i)) and a uniformly sampled K−1 frame from frame J to current frame (i), where J=i−B. The method also includes applying nonlinear dimensional reduction to map K-sample frames to a manifold, KSM(i), to a 2D embedded space and calculating a distance between start and end point of the manifold to predict changes in the current frame compared to the past. Additionally, the method includes storing the calculated distance in array T as i^{th} value of T.

In accordance with another aspect of the present invention, a method for detecting an object includes obtaining image data, wherein said image data comprises a frame and performing a moving objects detection to find the object in the frame. The method also includes performing a pattern recognition to classify the object and executing incremental manifold learning on the image data. Additionally, the method includes processing the image data with a trackogram protocol and assessing data from the pattern recognition and trackogram protocol in a rule-based decision making.

### BRIEF DESCRIPTION OF THE DRAWING

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 is a flow diagram of the present invention.

FIG. 2 illustrates an example of MovA applications in reaction to an anomaly detected in a crowded frame. By plotting the intra and interframe geodesic distances, a graph of crowd movement is visualized and the “anomalous” event appears as an outlier. The outlier was identified and tracked on the video and determined to be the biker.

FIG. 3 illustrates an example of the Trackogram from the complete video sequence in FIG. 2.

FIG. 4 is an overall scheme for Intra-Frame Processing sub-system of the present invention.

FIG. 5 is an isomap pipeline of the present invention.

FIG. 6 is an LLE pipeline of the present invention.

FIG. 7 is the pipeline of Recursive Real-Time manifold Learning to obtain a semantic crow behavior descriptor named Trackogram of the present invention.

FIG. 8 is the Rule-Based Decision making Unit: Steps to process Trackogram and calculate anomaly index.

FIGS. 9A-9D are the fully automatic and real-time anomaly tracking of a dataset according to the present invention.

FIGS. 10A-10D are the fully automatic and real-time anomaly tracking of a dataset according to the present invention.

FIGS. 11A and 11B are the fully automatic and real-time anomaly tracking of a biker from a dataset according to the present invention.

FIGS. 12A-12C illustrate fully automatic and real-time anomaly tracking of a night vision dataset: FIG. 12A illustrates typical frames; FIG. 12B illustrates a 2D view of manifold of video trajectory and location of frames in the manifold. To obtain this manifold a nonlinear DR method was applied; FIG. 12C illustrates Trackogram and anomaly index result. FIG. 12D shows the proposed InteF system was able to automatically detect anomaly (Squirrel or Fox) on-line

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention is directed to a system, hereinafter referred to as MovA, and methods therefor where MovA utilizes an embodiment of the present invention, a real-time manifold learning (RML) system. The RML and its method of use is capable of being integrated into different devices, including but not limited to, night vision cameras, drone and security cameras. The RML is suitable for real-time applications and can handle both small-scale and large-scale imagery data without need to save all prior image data. Importantly, it only needs new data when the data becomes available, due to the RML's incremental learning of motion pattern over time for anomaly detection. The incremental learning option of RML is only activated when the need to capture videos and analyze objects behavior over a long recording and image data that increases temporally. It is therefore, a preferred embodiment of the present invention to have a system that is capable of having an incremental learning capability with no need for saving and/or processing prior data. This feature is essential for real-time anomaly tracking as per the present invention, as opposed to previous systems that are based on supervised machine learning techniques with a need to use prior data and/or human interaction of labeling of anomalies for some previous data. In another preferred embodiment of the present invention, the RML allows for unsupervised automatic detection of moving objects and anomaly in both day and night conditions.

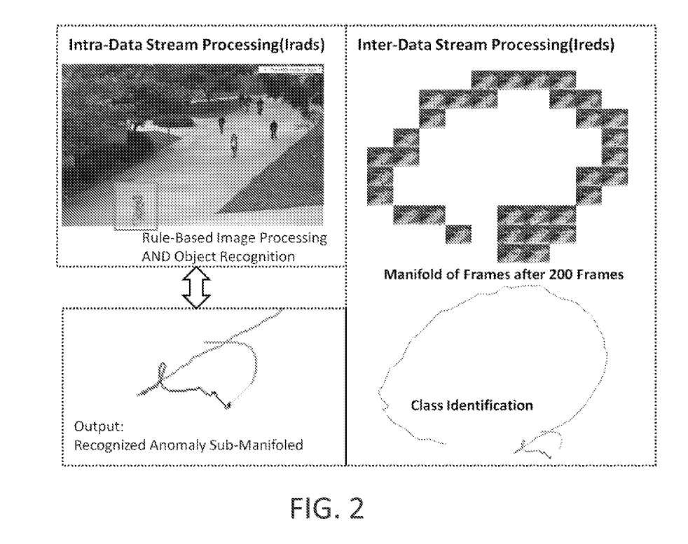

More particularly, MovA is an unsupervised, automatic method based on non-linear methods for anomaly object detection from stationary and/or non-stationary sensors (e.g., cameras, etc) and can be generalized to cover many scenarios. It is comprised of two “sub-systems” that enable the prediction and graphing of a motion pattern at the inter-frame and intra-frame level in real-time (no off-line processing) with the added ability to track moving objects in different frames. An example of an anomaly consists of a biker or skater going through a walking crowd or people “escaping” (see FIGS. 2, 10-12).

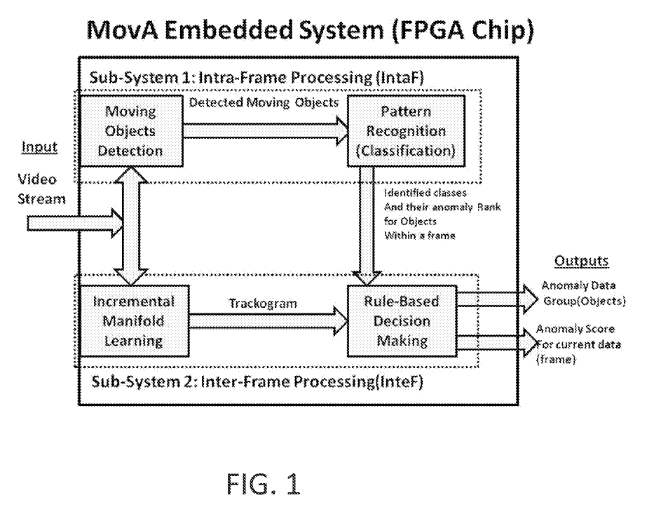

As shown in FIG. 1, the RML includes MovA having two main “sub-systems” that allow prediction of motion pattern at inter-frame and intra-frame in real-time and to track moving objects in any stationary and non-stationary scenes. As shown in FIG. 1, the two subsystems include 1) Intra-Frame Processing (IntaF) that is constructed so as to detect moving objects inside and within a frame and 2) Inter-Frame Processing (InteF) that is constructed so as to predict changes in scene over time which leads to detect anomaly in frames over time. By targeting the IntraF and InterF in this fashion the approach of the present method allows for greater flexibility and easier deployment on standard equipment to assist the user in difficult scenarios. For example, using MovA to define objects under night vision (NV) observation can yield a higher probability of success compared with current methods.

The method and system includes a real-time manifold distance learning (MDL) system that can Detect, Track, Identify and Locate (DTTIL) the objects. Second, a novel incremental non-linear dimensional reduction method (iNLDR) is also included. Finally, a preliminary demonstration of the method using very different input data sets to illustrate the usefulness of MovA is provided. The MDL methods can be integrated using embedded systems for remote devices, such as NV goggles, drone and security apparatus. The developed MDL has a reduced computational load, which makes it suitable for real-time applications, and the method can handle both small-scale and large-scale imagery data without the need to save all prior image data. MovA only needs new data when it becomes available for its incremental NLDR learning of the motion pattern over time. An incremental learning option can also be implemented for MDL, which, can be activated for the interF sub-system in situations, where the user needs to capture videos and analyze object behavior from long-time recordings. Moreover, this system can be integrated with other novel detection systems, such as event based imagers, to further reduce data to be processed and minimize the required communication bandwidth between the imager and the embedded processing system.

This is an advantage, since most object DTTIL methods are based on supervised machine learning techniques and require some means by which to label or train the system, which, could be difficult if quick decisions are required from the user. In addition, some methods rely on long-term data recording which increases the data load. These drawbacks can dramatically reduce applicability to real time applications. However, MovA overcomes these drawbacks with the iNLDR method, where both sub-systems can automatically DTTIL moving objects in both day and night conditions to alert the user to the need for action, if necessary.

The proposed system can provide critical capabilities for several military operational scenarios. For example, being able to detect multiple objects and identify them would lead to a potentially greater probability of hitting a high value target and reduce collateral damage. These systems could be used to reduce the clutter in NV goggles and highlight salient objects that would be defined for targeting. Moreover, this application of MovA could also be applied to detecting high value targets or anomalous movers in hyperspectral images or hyperspectral video streams.

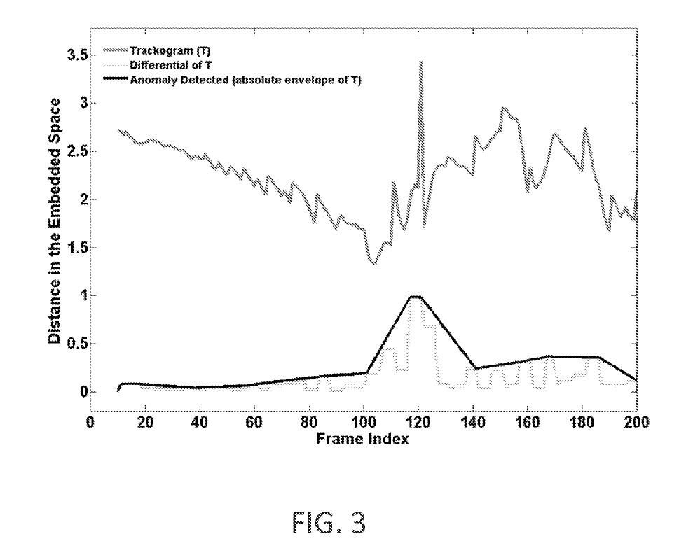

iNLDR is a method that maps each image (frame) to a point in an embedded 2D space. This is accomplished using a novel unsupervised non-linear mathematical algorithm. Moreover, for ease of interpretation, a new model to visualize this data and generate a two or three dimensional embedded maps can be used, according to the present invention, in which, the most salient structures hidden in the high-dimensional data appear prominently. This will allow the user to visualize factors not visible to the human observer such as unknown characteristics between imaging datasets and other factors (see FIG. 3). For example, in defense and intelligence applications, a wide range of information from surveillance or intercepts is logged daily from diverse sources such as human (HUMINT) or signal intelligence (SIGINT).

However, when plotted in a high dimensional space and reduced using the model, prominent related structures hidden in the high-dimensional space are revealed. Indeed, the embedded space is a unified description that captures both the appearance and the dynamics of visual processes of the objects under interrogation. The advantages of moving into higher dimensions, allows for better separation of the different manifolds and better delineation of the differences in geodesic distances between manifolds, which suggests improved object detection and identification. Moreover, using the iNLDR approach, allows for adaptive conditions to subtle changes that current algorithms cannot detect.

For example, most standard probability based identification methods can fail, if the dimensionality is large or the training data set has some bias. In addition, current popular machine learning approaches such as Support Vector Machines (SVM) need input parameters (such as kernel selection or the scale for radial basis function kernels) for correct obtaining the correct hyperplane boundaries. These potential problems can be overcome using the MovA system. iNLDR is a modified version of mathematical non-linear maps named Isomap, diffusion-Maps (DfM) and locally linear embedding (LLE). They have been modified for improved usability for real-time applications and incremental data mining. Compared to existing nonlinear dimensionality reduction techniques which can be very slow, iNLDR is fast and needs new data only when it becomes available and keeps the location of previous data (frames) in the embedded space for future use (as illustrated in FIGS. 2-3).

Real-Time Manifold Learning: To visualize the underlying manifold of high dimensional data manifold learning and dimensionality reduction methods are used, as more than three dimensions cannot be visualized. By definition, a manifold is a topological space which is locally Euclidean, i.e., around every point, there is a neighborhood that is topologically the same as the open unit ball in Euclidian space. Indeed, any object that can be “charted” is a manifold. Dimensionality reduction (DR) means the mathematical mapping of high-dimensional manifold into a meaningful representation in lower dimension using either linear or nonlinear methods. Intrinsic dimensionality of a data set or object presumed to mean the lowest characteristics that can represent the structure of the data. Mathematically, a data set X⊂R^{D(-array of image pixels)} has intrinsic dimensionality d<D, if X can be defined by d points or parameters that lie on a manifold. Dimensionality reduction methods map dataset X={x1, x2, . . . , xₙ}⊂R^{D(images)} into a new dataset Y={y1, y2, . . . , yₙ}⊂R_{d} with dimensionality d, while retaining the geometry of the data as much as possible. Generally, the geometry of the manifold and the intrinsic dimensionality d of the dataset X are not known. In recent years, a large number of methods for dimensionality reduction and manifold learning have been proposed which belongs to two groups: linear and nonlinear and are briefly Some popular linear techniques are: Principal Components Analysis, Linear Discriminant Analysis, and multidimensional scaling. There are a vast number of nonlinear techniques such as Isomap, Locally Linear Embedding, Kernel PCA, diffusion maps, Laplacian Eigenmaps, and other techniques. Nonlinear DR techniques have the ability to deal with complex nonlinear data. A vast number of nonlinear techniques are perfectly performed on artificial tasks, whereas linear techniques fail to do so. However, successful applications of nonlinear DR techniques on natural datasets are scarce. One of the important applications of manifold learning algorithms is to visualize image sets and classify images based on the embedded coordinates for object recognition. Some of applications were face recognition, pose estimation, human activity recognition and tracking objects in a video, where manifold learning has shown promising results. Most of the studies in this area have demonstrated that between different nonlinear manifold learning methods Diffusion-Maps, Isomap, and Locally Linear Embedding (LLE) performed well on the real datasets compared to other nonlinear techniques. Therefore, these three methods can be used to deal with object recognition, and will be described further herein.

Isomap: Dimensionality reduction methods maps dataset X into a new dataset Y with dimensionality d, while retaining the geometry of the data as much as possible. If the high-dimensional data lies on or near a curved manifold, Euclidean distance does not take into account the distribution of the neighboring data points and might consider two data points as near points, whereas their distance over the manifold is much larger than the typical inter-point distance. Isomap overcomes this problem by preserving pair-wise geodesic (or curvilinear) distances between data points. Geodesic distance (GD) is the distance between two points measured over the manifold. GDs between the data points could be computed by constructing a neighborhood graph G (every data point xᵢ is connected with its k nearest neighbors xᵢⱼ). GDs can be estimated using a shortest-path algorithm to find the shortest path between two points in the graph. GDs between all data points form a pair-wise GD matrix. The low-dimensional space Y is computed then by applying multidimensional scaling (MDS) While retaining the GD pairwise distances between the data points as much as possible. To do so, the error between the pairwise distances in the low-dimensional and high-dimensional representation of the data should be minimized: Σ(∥xᵢ−xᵢⱼ∥yᵢ−yᵢⱼμ)². This minimization can be performed using various methods, such as the eigen-decomposition of a pairwise distance matrix, the conjugate gradient method, or a pseudo-Newton method.

Diffusion maps (DfM): Diffusion maps find the subspace that best preserves the so-called diffusion interpoint distances based on defining a Markov random walk on a graph of the data termed Laplacian graph. It uses Gaussian kernel function to estimate the weights (K) of the edges in the graph:

$${K}_{ij} = {e}^{- \frac{{‖ {x}_{i} - {x}_{i} ‖}^{2}}{2 {σ}^{2}}}$$

. In the next step, the matrix K is normalized in a way that its rows add up to 1:

$${p}_{ij}^{( t )} = \frac{{K}_{ij}}{{\sum }_{m} {K}_{im}} ,$$

where P represents the forward transition probability of t time steps random walk from one data point to another data point. The diffusion distance is defined as:

$${D}_{ij}^{( t )} = {\sum }_{m} \frac{{( {p}_{im}^{( t )} - {p}_{jm}^{( t )} )}^{2}}{Ψ ( {x}_{m} )} , \\ Ψ ( {x}_{m} ) = \frac{{\sum }_{j} {p}_{jm}}{{\sum }_{k} {\sum }_{j} {p}_{jk}} .$$

In the diffusion distance parts of the graph with high density has more weight. Also pairs of data points with a high forward transition probability have a small diffusion distance. The diffusion distance is more robust to noise than the geodesic distance because it uses several paths through the graph. Based on spectral theory on the random walk, the low-dimensional representation Y can be obtained using the d nontrivial eigenvectors of the distance matrix D: Y={λ₂V₂, . . . λ_{d}V_{d}}. As the graph is fully connected, eigenvector v1 of the largest eigenvalue (λ₁=1) is discarded and the eigenvectors are normalized by their corresponding eigenvalues.

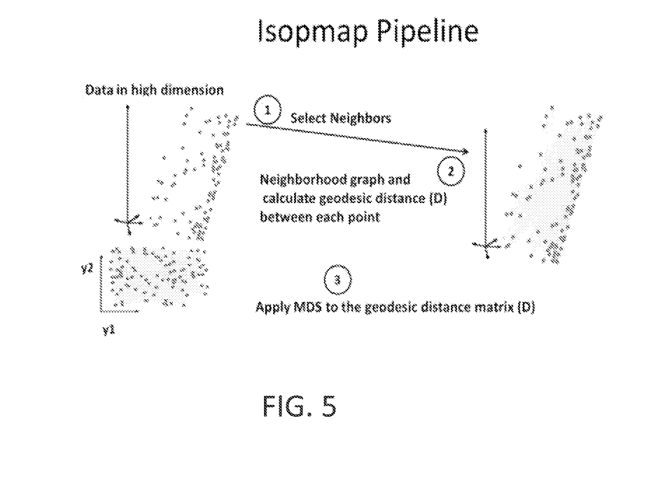

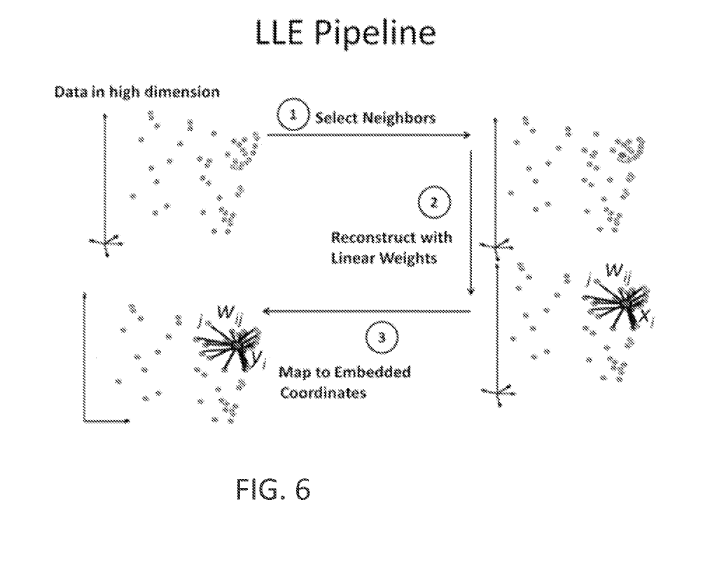

Locally Linear Embedding (LLE): As shown in FIGS. 5 and 6, in contrast to Isomap, LLE preserves local properties of the data which allows for successful embedding of nonconvex manifolds. LLE assumes that the global manifold can be reconstructed by “local” or small connecting regions (manifolds) that are overlapped. If the neighborhoods are small, the manifolds are approximately linear. LEE performs a type of linearization to reconstruct the local properties of the data by using weighted summation of the k nearest neighbors for each point. Thus, any linear mapping of the hyperplane to a space of lower dimensionality preserves the reconstruction weights. This allows using the reconstruction weights Wᵢ to reconstruct data point yᵢ from its neighbors in the reduced dimension. So, to find the reduced (d) dimensional data representation Y the following cost function should be minimized for each point xi:

$$ɛ ( W ) = {\sum }_{i = 1}^{n} {‖ {x}_{i} - {\sum }_{j = 1}^{k} {w}_{ij} {x}_{ij} ‖}^{2}$$

Subject to two constraints

$${\sum }_{j = 1}^{k} {w}_{ij} = 1$$

and wij=0 when xⱼ∉R^{D(image pixels)}. Where X is input data, n is number of points and k is neighborhood size. The optimal weights matrix W (n×K) subject to these constraints are found by solving a least-squares problem. Then, the embedding data (Y) is computed by calculating the eigenvectors corresponding to the smallest d nonzero eigenvalues of the matrix. FIG. 3 shows steps for LLE.

Sub-System 1: Intra-Data Stream Processing (IntaF): In this sub-system, individual object movements are detected within a frame. Intaf is a two stage process.

Moving Objects Detection: In this step, the current frame is registered with previous frame, Second, individual moving objects are detected by subtracting current frame from previous frame to exclude static and stationary objects in the frame. Next, the subtracted frame is t converted to a binary image using Otsu thresholding. Then, shape analysis is done on the binary image by computing following properties: a) Area; b) Orientation; c) Bounding Box; d) Centroid; d) Major Axis Length and e) Minor Axis Length. Based on these features, a rule is defined to exclude small and line shape areas from the binary image and collect the centroid with a minimum bounding box (a box which all the points of identified object lie on it) for all identified moving objects.

Pattern (object) Recognition: In this step, the identified objects are classified within the frame using pattern recognition techniques. Currently there are a vast number of pattern recognition methods developed to recognize objects in a set of images. These methods can be classified to two groups: supervised and supervised techniques: Popular supervised techniques such as support vector machine (SVM) and artificial neural networks (NN) and have been applied in several applications, such as, face recognition, pose estimation, human body activity, etc. However, the major drawback is the need for prior training with manual labeling of objects. This can have detrimental effects on the performance with an increase in the size the training data. This limits supervised methods for real-time applications.

Object Recognition Manifold Learning: These three nonlinear manifold learning methods explained above can be used to deal with object recognition and tracking.

Manifold Learning Steps: 1) Reconstruct data point cloud (X): suppose number of image patches are N and equalize patch sizes to L1×L2. In this application of manifold learning, number of dimensions is equal to number of pixels. Therefore the size of point cloud (X) will be a matrix with the size of L×N, where L=L1*L2. 2) Apply nonlinear dimensionality reduction (manifold learning) algorithm to reduce dimension of L to 2. This step returns a 2D matrix, P, with matrix size of N×2, where N is number of detected objects by rule-based image processing step. Each data point of P represents an image patch.

Class Identification After applying Manifold Learning, then an additional step of class identification is applied to segment manifold of objects obtained by nonlinear DR techniques and identify classes for normal and abnormal objects in the frame.

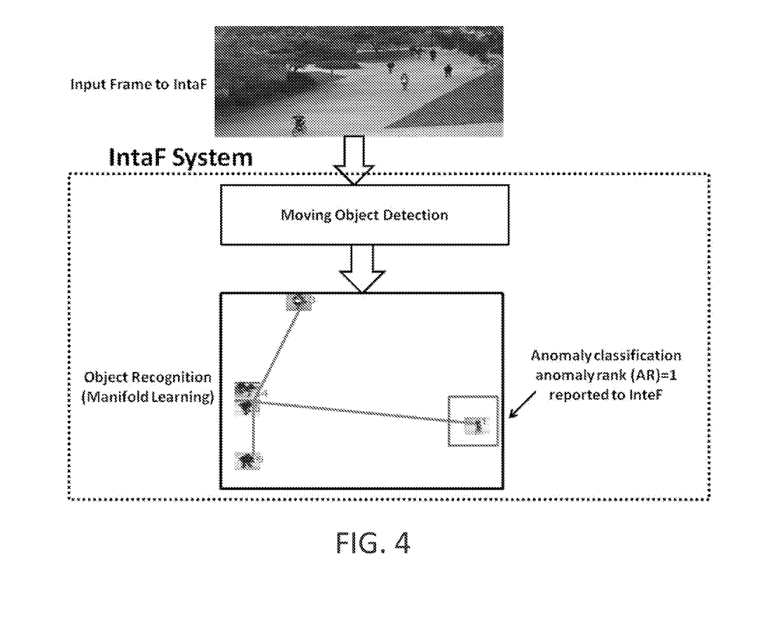

Steps: 1) Calculate pair-wise distance matrix (D) for matrix P in the embedded space. 2) For each data point (Pᵢ), the nearest point is found by computing minimum value of distances in corresponding row in matrix D to obtain an array named Dₘᵢₙ with the size of N, where N is number of detected objects. 3) Calculate mean and 95% confidence interval (CI) on mean of Dₘᵢₙ, name it as Dₘₑₐₙ. 4) Look at first row of matrix D and find data points which their distances from first data point are within the range of [Dₘₑₐₙ−CI, Dₘₑₐₙ+CI]. Those points belongs to class 1 and remove their corresponding rows from matrix D. 5—repeat step 4 for remaining rows of matrix D. 6—Find which class has the highest population and label it as normal class. 7—Calculate centroid of all classes. 8—Calculate distances between centroid of normal class (C_{N}) and other classes. 9—Find which object has the maximum distance from other detected objects in the embedded space and label it as anomaly object and the class that it belongs as anomaly class. 10—Abnormality Rank: Normalize distances calculated in step 8 and report it as abnormality rank (AR). AR=1 represents the most suspicious class of objects and one of its objects (most suspicious object) has the maximum distance from other detected objects in the embedded space. By applying these steps, all N detected objects will belong to a class and number of classes (Nₒⱼ) varies based on object type and shape. The identified classes for all objects and their AR as well as most suspicious object will be reported to the InteF sub-system. FIG. 4 shows the overall scheme for IntaF and objection recognition.

Sub-System 2: Inter-Data Stream Processing (InteF): In this sub-system, changes are predicted in frame over time which leads us to detect anomaly in scenes over time. InteF is a two stage process.

Trackogram: Real-Time Manifold Learning: Standard nonlinear DR methods are non-incremental techniques and cannot be used in real-time applications. Standard DR methods can only work if the entire frames are available and they can be used off-line to map video trajectories from hi ah dimension space to a 2D embedded space. Segmenting and interpretation of such a trajectory which visualize both global and sub-manifolds (sub-spaces) is hard and subjective. However, the proposed incremental DR technique named Trackogram which is described below designed to deal with sub and local manifolds on-line and in real-time.

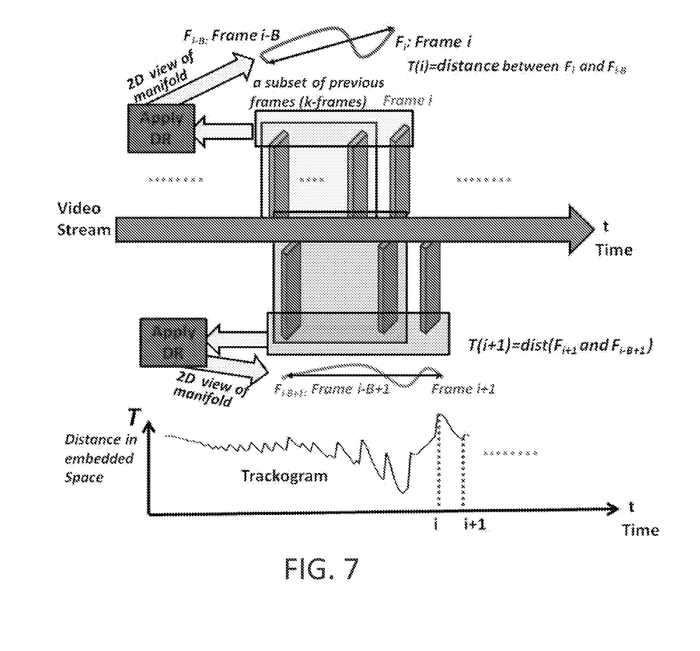

In this step, the proposed real-time manifold learning algorithm is used to predict a real-time semantic and analytic crowd behavior descriptor using a manifold formed by a sub-sample of previous frames and current video frame. This means the manifold of video frames is recursively updated over time to track normal and abnormal crowd behavior in an unsupervised and automatic manner. FIG. 7 shows diagram of real-time manifold learning (RML). As can be seen in FIG. 7, for each frame a k-sample-manifold is formed, which is smoothly updated over time and a nonlinear DR method (Diffusion-maps or Isomap) is used to map k-sampled manifold from L dimensional space to 2D embedded space, where k is user defined control parameter and preferably it is set at a value bigger than 10 to have a reliable estimation of underlying manifold and robust singular value decomposition during DR operation.

If frame matrix size is N1×N2, L equals to N1−N2. After k-sample-manifold representing manifold of video frame is mapped around current frame to the 2D embedded space, distance is calculated between start and end point of embedded manifold to predict changes in the current frame compared to the past. The calculated distance in the embedded space is used as a semantic descriptor of video frames and track its change over time to obtain a graph of crow behavior over time which is referred to as Trackogram (see FIG. 5). Below are steps to calculate Trackogram.

Trackogram Steps: 1—Wait until K frames occur. 2—Obtain k-sample manifold: Collect current frame (F(i)) and uniformly sampled k−1 frames from frame J to current frame (i), where J=i−B. B is a user-defined value and shows how far back to go to obtain history of crow behavior. 3—Apply nonlinear DR to map k-sample manifold, KSM(i), to the 2D embedded space. 4—calculate distance between start and end point of embedded manifold to predict changes in the current frame compared to the past. Store the calculated distance in array T (Trackogram) as ith value of T. 5—New frame (F(i+1)) happened: go to step 2 and incrementally update k-sample manifold, to obtain updated manifold KSM(i+1), and then repeat steps 3 and 4 for this new frame (F(i+1)).

Anomaly Detection using a Rule-Based Decision Making: To detect anomaly in crow behavior over time, first calculate derivative of Trackogram (dT/dt) to detect sudden changes in crow behavior, where t represents time. Then calculate subtraction of upper and lower envelope of dT/dt and use it as a proposed anomaly index, which is indeed a continuous index and thresholding algorithm could be used to obtain a binary anomaly detection index. IntaF sub-system provides this unit the identified classes for all objects and their AR as well as the most suspicious objects. If anomaly index is increased dramatically compared to the past (baseline) and stays high for two consecutive frames, this unit from Ired sub-system consider the most suspicious objects as anomaly in the current frame. Summary of algorithm and rules set by this unit are as following:

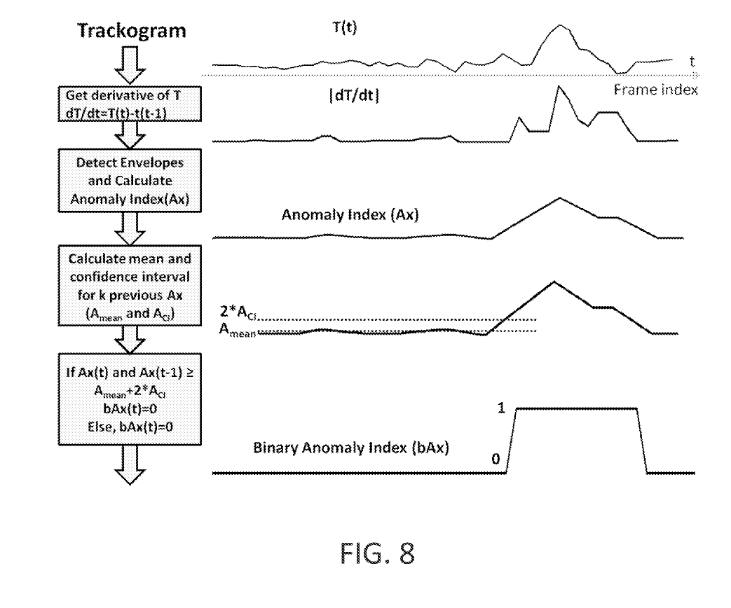

1—Find derivative of T, dT/dt═T(t)−T(t−1), where t is the frame index for the current frame. 2—Find upper and lower envelopes of dT/dt. 3—Calculate anomaly index (Ax) Ls as subtraction of upper and lower envelope of dT/dt. 4—Calculate average (Aₘₑₐₙ) and confidence interval (A_{CI}) of k previous values of anomaly index (Ax). 5—If anomaly index value for current and previous frames are bigger than Aₘₑₐₙ+2*A_{CI}, report the most suspicious objects in the current frame (reported by IntaF sub-system) as anomaly (anomalies) in the current frame. FIG. 8 shows these steps.

PRELIMINARY DATA: To validate the proposed method and system, the method was applied to following the crowd activity benchmark datasets.

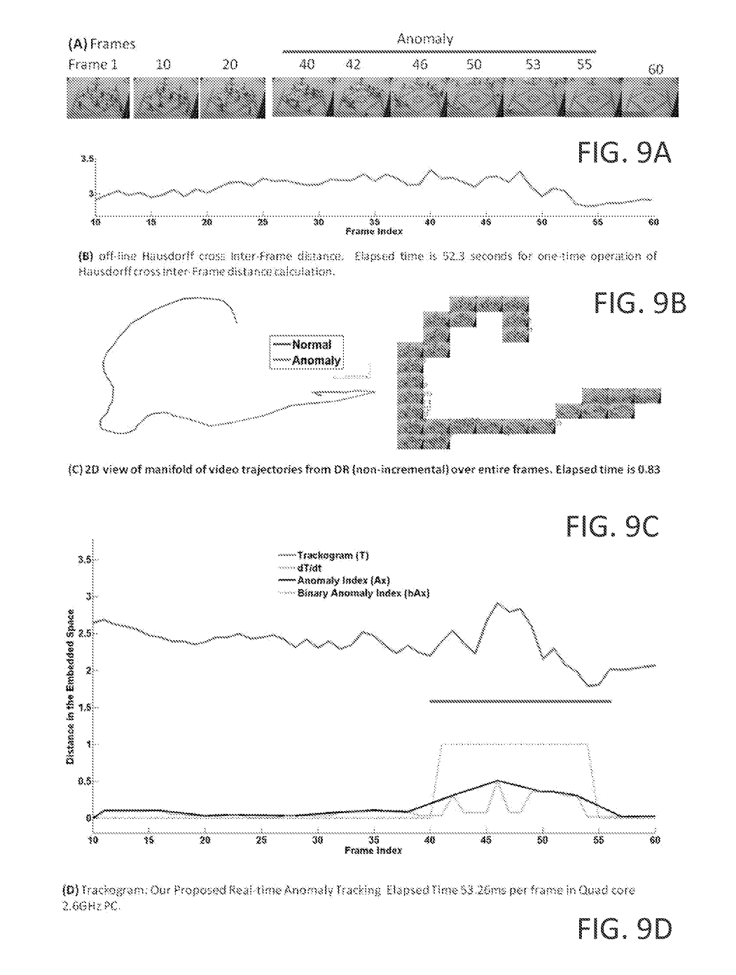

University of Minnesota dataset (UMN 2009):This dataset includes several video sequences of three different scenarios. A 3rd scenario with a normal starting section and abnormal ending section was also used. A group of people start running (anomalous behavior) after several times randomly rotating in a circle in the beginning part of video. FIGS. 9A-9D show some typical frames of the video, 2D view of manifold of video trajectory and location of frames in the manifold, and corresponding trackogram and anomaly index. FIG. 9B shows a 2D view of manifold of video trajectories mapped from high dimension space to a 2D embedded space by use of standard non-incremental nonlinear DR methods. Segmenting and interpretation of such a trajectory which visualizes both global and sub-manifolds (sub-spaces) is hard and subjective. However, the proposed incremental DR technique named Trackogram designed to deal with sub and local manifolds on-line and in real-time. FIG. 9D shows the proposed Trackogram method in InteF sub-system was able to automatically detect anomaly (people escaping) and frames that anomaly happened without a subjective manually labeling and prior training.

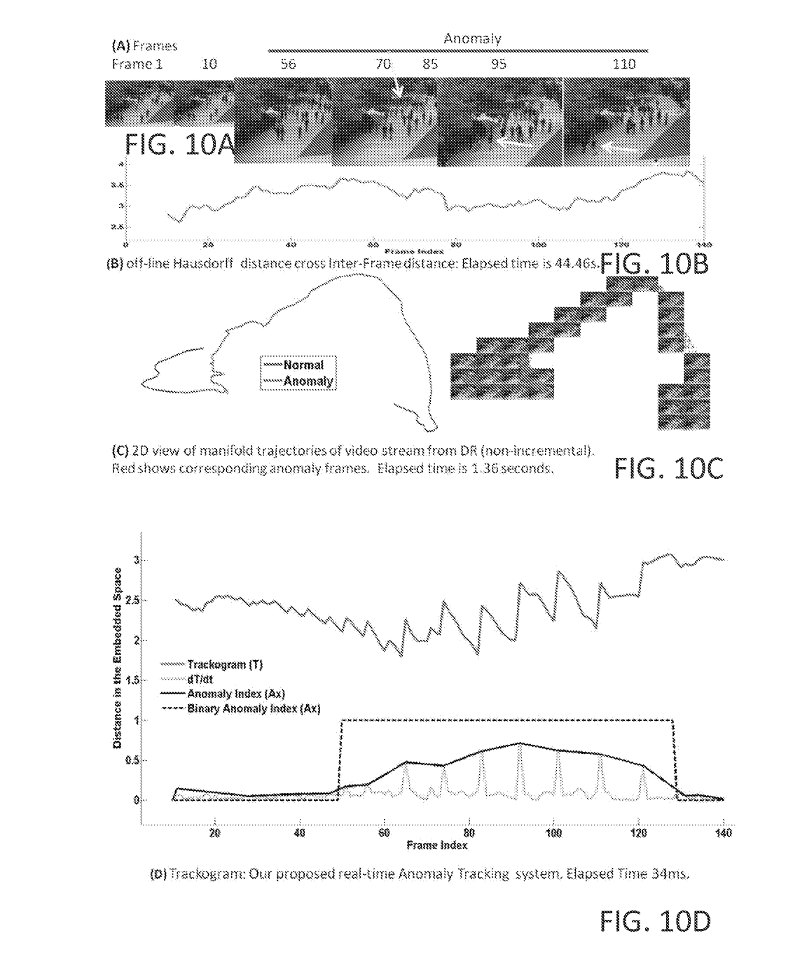

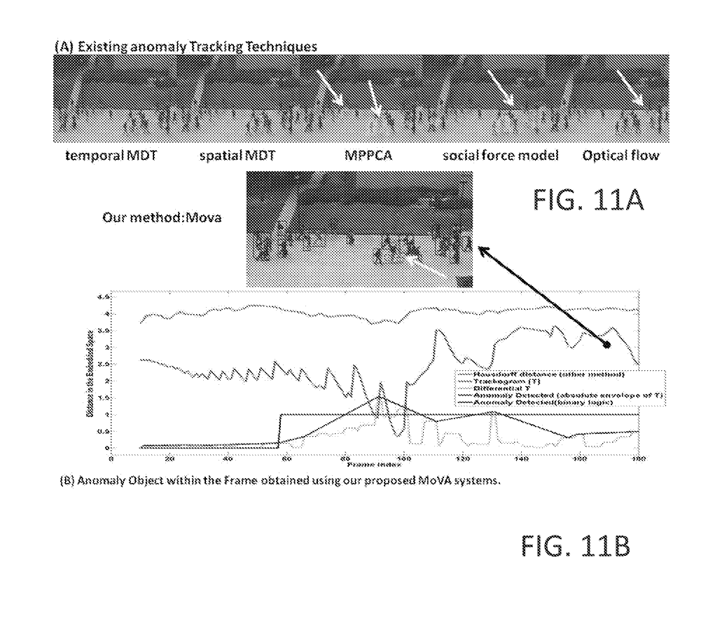

2) University of California, San Diego Anomaly Dataset (UCSD 2010): This dataset includes several video sequences of four different scenarios, biker, wheelchair, cart and skater. A difficult anomaly case (skater and biker) was used to test the proposed methods. In skater case, a skater enters the scene in frame 60 and it is in the scene till end. FIGS. 10A-10D show some typical frames of the skater scenes, 2D view of manifold of frames trajectory and location of frames in the manifold, and corresponding trackogram and anomaly index. FIG. 10D shows that the proposed InteF system was able to automatically detect anomaly (skater) and frames that anomaly happened. UCSD group compared their proposed anomaly detection methods named temporal and spatial mixture of dynamic textures (MDT) against Mixtures of Probabilistic Principal Component Analyzers (MPPCA), Social Force Model and optical flow methods. FIG. 11 compares results of these methods in comparison to the proposed MovA system results for a typical frame. As can be seen spatial and temporal MDT methods as well as optical flow method failed to track anomaly (biker). MPPCA and Social Force Model picked other objects in addition to anomaly (biker). However, the method, MovA, was able to track objects with no error. Comparison test with other methods (see above), using Mixtures of Dynamic Textures (MDT), social force model, and optical flow.

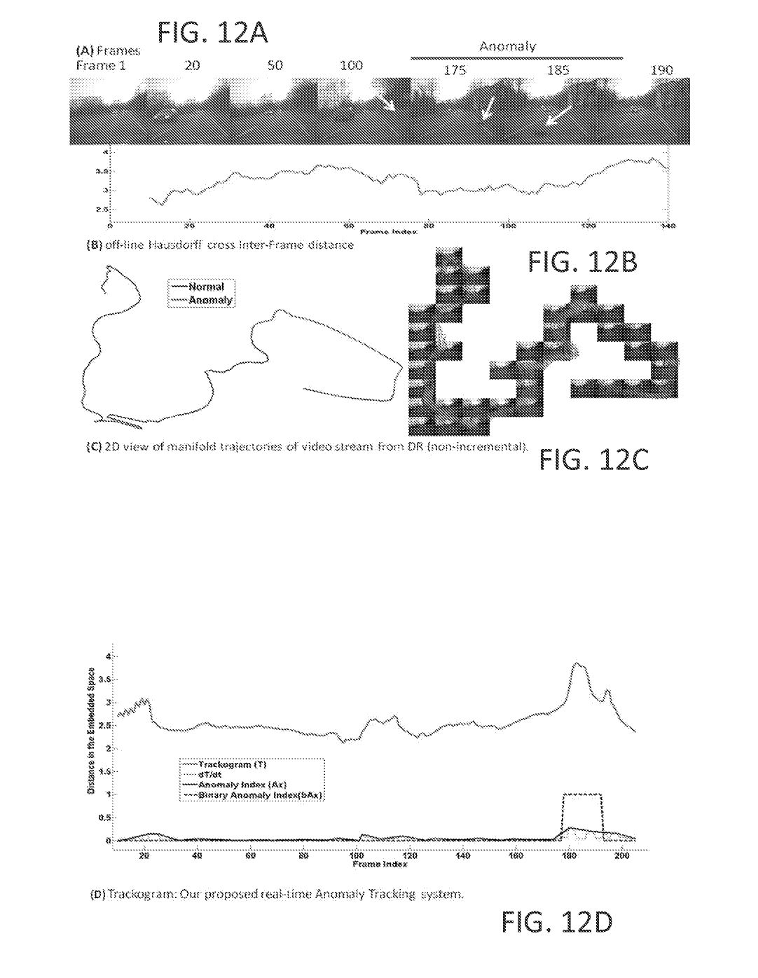

Night vision stereo sequences provided by Daimler AG Company in June 2007: This dataset includes several video sequences of seven different scenarios, Construction-Site, Crazy-Turn, Dancing-Light, Intern-On-Bike, Safe-Turn, Squirrel, and Traffic-Light. Another difficult anomaly case (Squirrel or Fox) was used to test the proposed methods. In Squirrel case, a squirrel enters the scene in frames. FIGS. 12A-12C shows some typical frames of the video, 2D view of manifold of video trajectory and location of frames in the manifold and corresponding trackogram and anomaly index. FIG. 12D shows the proposed InteF system was able to automatically detect anomaly (Squirrel or Fox) on-line.

Novel variational optical flow techniques as well as efficient tracking techniques using kernel methods and particle filters can also be used in conjunction with the present method. These approaches will be used alongside the iNLDR techniques to find motion anomalies that would point to suspicious or unusual activities. In this case, motion flow would be dimensionality reduced via iNLDR then either Support Vector methods or geodesic-distance based approaches would be used for recognition or discrimination. Additional techniques developed to find anomalies from high dimensional data (in particular hyperspectral data) based on Machine Learning techniques and in particular Support Vector Data Description (SVDD) can also be used with the present invention. SVDD can be used in sub-manifold spaces representing scenes, 3D motion, or images to determine that behave as outliers.

Hyperspectral Imagery: In addition to applying the iNLDR method to NV goggles, these algorithms can also be used to solve detection and tagging problems in hyperspectral imagery. Hyperspectral imagery consists of high resolution spectral information, providing thousands of bands for each image pixel, thereby encoding the reflectance of the object and/or material of interest across a specific swath of the EM spectrum, typically spanning the visible and IR ranges. Because it is able to see the fine spectral signature of the materials, a hyperspectral camera is able to discriminate between fine changes in reflectance. However the high dimensionality of the data (what is acquired is a data cube several times a second, this data cube itself consisting of thousands of images, one per spectral band), this type of data is an ideal candidate for processing using DR algorithms.

Unfortunately, most dimensionality reduction algorithms are subject to the possibility of loss of critical subspaces (features) that are most discriminative for anomaly detection or object recognition purposes. This is not the case of the iNLDR approach. Therefore, several strategies for performing anomaly/target detection and leveraging the iNLDR approach, can also be used in conjunction with the present method as follows: (a) by performing anomaly detection directly in the dimensionality reduced hyperspectral image space; and comparing it to (b) existing methods developed relying on support vector data description (SVDD) or RX detector directly on the original hyperspectral space; and finally comparing the two approaches to (c) performing SVDD or RX detection in the dimensionality reduced space. Both global and local referentials can be used, in order to characterize global anomalies as well as fine anomalies that consist of subtle differences between groups (i.e. being able to distinguish a car between mostly trucks is a global anomaly, while being able to distinguish a specific blue ford explorer with fine/abnormal variation of tint among a set of blue ford explorers is a local anomaly). Finding local referential will be accomplished by clustering images in the submanifold, and for each cluster, finding a subset of images that can help define a local referential system. The interplay of the dimensionality reduction used via iNLDR, and the implicit increase in dimensionality brought about by the use of the SVDD when using Gaussian Radial Basis Functions, to allow for the definition or non-linear decision boundaries.

Image vs Feature spaces: Anomaly detection can also be carried out, not in the dimensionality reduced image space, but instead in the iNLDR-dimensionality reduced feature space. One possibility is to concatenate Scale Invariant Feature Transform (SIFT) or SpeededUp Robust Feature (SURF) features vectors of salient image feature point found in the image. Such a comparison would allow the performance of object detection or anomaly detection by efficiently computing geodesic distances in the dimensionality reduced feature space. To address the issue of how to actually combine these features in a way that is consistent across images and invariant to their location in the image, one possibility is to use a bag of visual Words approach (BOW) and to take as feature vectors the frequency at which the visual word appears in the image. Another possibility to perform this while still encoding the important information of the object location to use spatial pyramids with BOW as was proposed recently in combination of iNLDR.

The system and method can also be integrated into available embedded chips, such as Field Programmable Gate Arrays (FPGA). FPGAs provide a reconfigurable, massively parallel hardware framework on which such systems can be implemented. This enables fast computations that can out-perform Graphical Processor Units (GPU) if the problem is be fine-grained parallelizable.

The MovA algorithm maps readily to the FPGA computation fabric, allowing the entire system to be realized a medium to large scale FPGA. FPGA operates at 1000×−100× faster compared to CPU. Furthermore, these FPGA systems are much more compact and use much less power than their CPU and GPU counterparts, allowing them to be embedded into mobile platforms such as robots, UAVs and wearable devices such as NV goggles.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A system for detection of an object comprising:
a source of image data for providing image data, wherein said image data comprises a frame;
a real-time learning manifold system (RML) disposed on a fixed computer readable medium comprising:
a first subsystem configured to provide prediction of motion pattern intra-frame, such that the object is detected moving within the frame; and
a second subsystem configured to provide prediction of motion pattern inter-frame, such that changes over time in a scene contained in the image data are predicted.

2. The system of claim 1 wherein the image data further comprises video.

3. The system of claim 1 wherein the image data further comprises temporally contiguous frames.

4. The system of claim 1 wherein the source of image data further comprises a video capture device.

5. The system of claim 4 wherein the video capture device is in communication with the RML such that the image data is transmitted directly to the RML.

6. The system of claim 4 wherein the video capture device takes the form of a night-vision video capture device.

7. The system of claim 1 wherein the RML further comprises at least one selected from a group consisting of diffusion maps, isomap, and locally linear embedding for detection of the object.

8. The system of claim 1 wherein the first subsystem is further configured to register a current frame with a previous frame to generate a subtracted frame excluding static and stationary objects in the frame; convert the subtracted frame to a binary image; perform shape analysis on the binary image.

9. The system of claim 1 wherein the first subsystem is further configured to classify the object in the frame using pattern recognition.

10. The system of claim 1 wherein the second subsystem is further configured to implement Trackogram.

11. The system of claim 1 wherein the second subsystem is further configured to detect an anomaly using a rule-based decision making process.

12. A method for real-time tracking comprising:
obtaining K sample frames;
collecting a current frame (F(i)) and a uniformly sampled K−1 frame from frame J to current frame (i), where J=i−B;
applying nonlinear dimensional reduction to map K-sample frames to a manifold, KSM(i), to a 2D embedded space;
calculating a distance between start and end point of the manifold to predict changes in the current frame compared to the past; and
store the calculated distance in array T as i^{th} value of T.

13. The method of claim 12 further comprising obtaining a new frame K+1.

14. The method of claim 13 further comprising obtaining an updated manifold.

15. A method for detecting an object comprising:
obtaining image data, wherein said image data comprises a frame;
performing a moving objects detection to find the object in the frame;
performing a pattern recognition to classify the object;
executing incremental manifold learning on the image data;
processing the image data with a trackogram protocol; and
assessing data from the pattern recognition and trackogram protocol in a rule-based decision making.

16. The method of claim 15 further comprising obtaining an anomaly dataset group.

17. The method of claim 15 further comprising obtaining an anomaly score for current data in the frame.

18. The method of claim 15 further comprising obtaining the image data from a video capture device.

19. The method of claim 15 further comprising the method being disposed on a fixed computer readable medium.

20. The method of claim 15 further comprising implementing a first subsystem configured to provide prediction of motion pattern intra-frame, such that the object is detected moving within the frame and a second subsystem configured to provide prediction of motion pattern inter-frame, such that changes over time in a scene contained in the image data are predicted.
